(19) United States
(12) Patent Application Publication
(10) Pub. No.: US 2021/0245716 A1
(43) Pub. Date: Aug. 12, 2021

(54) WIPER-FASTENING APPARATUS, WIPER BLADE ASSEMBLY, AND WIPER DEVICE

(71) Applicant: CAP CORPORATION, Gyeongsangbuk-Do (KR)

(72) Inventors: Tae Hun KIM, Daegu (KR); Young Hun LIM, Gyeongsangbuk-do (KR)

(21) Appl. No.: 17/096,206

(22) Filed: Nov. 12, 2020

(30) Foreign Application Priority Data
Feb. 7, 2020 (KR) 10-2020-0015084

(51) Int. Cl. B60S 1/40

(52) U.S. Cl. CPC B60S 1/4064; B60S 1/4041

(57) ABSTRACT

Related are a wiper-fastening apparatus, a wiper blade assembly, and a wiper device. The wiper-fastening apparatus configured to fasten a wiper arm coupling adaptor to a wiper blade includes a base attached to or detached from a clamp fixed to the wiper blade and on which the adaptor is mounted to be hinge-rotated. Here, the base includes a hinge portion which is hinge-coupled to the adaptor and a lateral portion extending downward from both sides in a width direction of the hinge portion and inside which the wiper blade is mounted. Also, the lateral portion includes a protruding portion biased from the clamp or held by the clamp in a vertical direction depending on an angle formed by a longitudinal direction of the wiper blade and a longitudinal direction of the hinge portion.

### CROSS-REFERENCE TO RELATED APPLICATION

This application claims priority to and the benefit of Korean Patent Application No. 10-2020-0015084, filed on Feb. 7, 2020, the disclosure of which is incorporated herein by reference in its entirety.

### BACKGROUND

### 1. Field of the Invention

The present invention relates to a wiper-fastening apparatus, a wiper blade assembly, and a wiper device, and more particularly, to a wiper-fastening apparatus, a wiper blade assembly, and a wiper device, which are configured to simply attach or detach a blade to or from an adaptor.

### 2. Discussion of Related Art

Generally, a wiper apparatus is installed in a vehicle or the like to clean a surface of a windshield. The wiper apparatus may include a wiper motor, a wiper arm, a wiper blade, and the like, and an adaptor may be used for a structural connection between the wiper arm and the wiper blade.

The wiper arm is connected to a rotational shaft of the wiper motor at a bottom end and reciprocates due to the wiper motor. One or more wiper arms are provided according to a size of the windshield. When a plurality of wiper arms are provided, they are provided not to interfere with each other in rotation.

In addition, the wiper blade may be separably coupled to an end of the wiper arm through the adaptor. The wiper blade is provided in a linear shape, remains in a state of being pressed against the windshield, and slides against and wipes the surface of the windshield due to movement of the rotating wiper arm.

Since the wiper blade is rubbed continuously against the windshield while being installed in the vehicle, as time passes, the wiper blade may be worn, generate unnecessary noise, or decrease in performance of cleaning the surface.

Accordingly, it is necessary to continuously replace the wiper blade. Here, a user of the vehicle separates an existing wiper blade from the wiper arm and then fastens a new wiper blade.

Also, since the adaptor configured to connect the wiper blade to the wiper arm is also separated from the wiper blade as necessary, the adaptor may be reused and only the wiper blade may be replaced.

In this case, it is necessary not only to easily separate the adaptor and the wiper blade from each other but also to maintain a state in which the wiper blade is stably pressed against the windshield despite windage resistance or the like when they are fastened. Accordingly, an effective structure for connecting a wiper blade to an adaptor has been studied and developed continuously.

### SUMMARY OF THE INVENTION

The present invention is directed to providing a wiper-fastening apparatus, a wiper blade assembly, and a wiper device, which are configured to easily attach or detach a clamp provided on a blade side to or from a base provided on an adaptor side by improving a coupling structure thereof.

According to an aspect of the present invention, there is provided a wiper-fastening apparatus configured to fasten a wiper arm coupling adaptor to a wiper blade. The wiper-fastening apparatus includes a base attached to or detached from a clamp fixed to the wiper blade and on which the adaptor is mounted to be hinge-rotated. Here, the base includes a hinge portion which is hinge-coupled to the adaptor and a lateral portion extending downward from both sides in a width direction of the hinge portion and inside which the wiper blade is mounted. Also, the lateral portion includes a protruding portion biased from the clamp or held by the clamp in a vertical direction depending on an angle formed by a longitudinal direction of the wiper blade and a longitudinal direction of the hinge portion.

The lateral portion may include a parallel surface portion provided to be parallel to the longitudinal direction of the hinge portion and a tilted surface portion provided to be tilted outward at a certain angle in comparison to the parallel surface portion so as to switch between a first state in which the wiper blade is mounted to be parallel to the tilted surface portion and a second state in which the wiper blade rotates and is mounted to be parallel to the parallel surface portion in comparison to the first state. Here, the parallel surface portion may include the protruding portion held by the clamp fixed to the wiper blade in the second state.

In the first state, the protruding portion may be biased and released from the clamp fixed to the wiper blade.

In a pair of such lateral portions provided on both sides of the hinge portion, the parallel surface portion and the tilted surface portion may be arranged to form point symmetry on the basis of a center about which the wiper blade rotates.

The clamp including a fixing portion fixed to the wiper blade and a holding portion extending from at least one side of the fixing portion to form a gap between the holding portion and the wiper blade may be further included. The base may include a hook portion configured to deviate from the gap in the first state and to be inserted into the gap to be held by the holding portion in the second state.

The base may further include a locking portion configured to interfere with a side surface of the clamp fixed to the wiper blade and to block rotations of the clamp in the second state.

The locking portion may have a cantilever shape provided to be movable in a vertical direction due to the elastic force and be configured to be switchable between a locked state of facing the side surface of the clamp and blocking the rotations of the clamp and an unlocked state of being elastically deformed to be biased from the side surface of the clamp and allowing the rotations of the clamp.

The locking portion may include a protrusion protruding downward. In the locked state, the protrusion may face the side surface of the clamp and block the rotations of the clamp to be locked. In the unlocked state, the protrusion may be biased from the side surface of the clamp in a vertical direction and allow the rotations of the clamp to be unlocked.

According to another aspect of the present invention, there is provided a wiper blade assembly. The wiper blade assembly includes a wiper blade including a contact member configured to be pressed against a surface of a target to be pressed against and to slide along the surface, a cover member provided on the contact member to be on an opposite side to the target, and an elastic member configured to apply an elastic force to the contact member and includes a fastening apparatus including a clamp fixed to the elastic member and a base attached to or detached from the clamp and on which an adaptor configured to couple with a wiper arm is mounted to be hinge-rotated. Here, the base includes a hinge portion hinge-coupled to the adaptor and a lateral portion extending downward from both sides of the hinge portion in a width direction and inside which the elastic member is mounted. The lateral portion includes a protruding portion configured to be biased from or held by the clamp fixed to the elastic member depending on an angle formed by a longitudinal direction of the elastic member and a longitudinal direction of the hinge portion.

The lateral portion may include a parallel surface portion provided to be parallel to the longitudinal direction of the hinge portion and a tilted surface portion provided to be tilted outward at a certain angle in comparison to the parallel surface portion so as to switch between a first state in which the elastic member is mounted to be parallel to the tilted surface portion and a second state in which the wiper blade rotates in comparison to the first state and the elastic member is mounted to be parallel to the parallel surface portion. Here, the parallel surface portion may include the protruding portion held by the clamp fixed to the wiper blade in the second state.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of a wiper device according to a first embodiment of the present invention;

FIG. 2 is a perspective view of a wiper blade assembly according to the first embodiment of the present invention:

FIGS. 3 and 4 are exploded-perspective views of the wiper blade assembly according to the first embodiment of the present invention;

FIGS. 5 and 6 are perspective views of a wiper-fastening apparatus according to the first embodiment of the present invention;

FIGS. 7 to 9 are views illustrating a method of using the wiper-fastening apparatus according to the first embodiment of the present invention:

FIG. 10 is a perspective view of a wiper device according to a second embodiment of the present invention:

FIG. 11 is a perspective view of a wiper blade assembly according to the second embodiment of the present invention;

FIGS. 12 and 13 are exploded-perspective views of the wiper blade assembly according to the second embodiment of the present invention:

FIGS. 14 and 15 are perspective views of a wiper-fastening apparatus according to the second embodiment of the present invention;

FIG. 16 is an exploded perspective view of the wiper-fastening apparatus according to the second embodiment of the present invention; and

FIG. 17 is a view illustrating a method of using the wiper-fastening apparatus according to the second embodiment of the present invention.

### DETAILED DESCRIPTION OF EXEMPLARY EMBODIMENTS

The aspects, particular advantages, and novel features of the present invention will become apparent from a detailed description of exemplary embodiments with reference to the attached drawings. While reference numerals are given to components of each drawing, it should be noted that although shown in different drawings, like components will be referred to with like reference numerals if possible. Also, in a description of the embodiments of the present invention, a detailed description of well-known components or functions of the related art will be omitted when it is deemed to obscure understanding of the embodiments of the present invention.

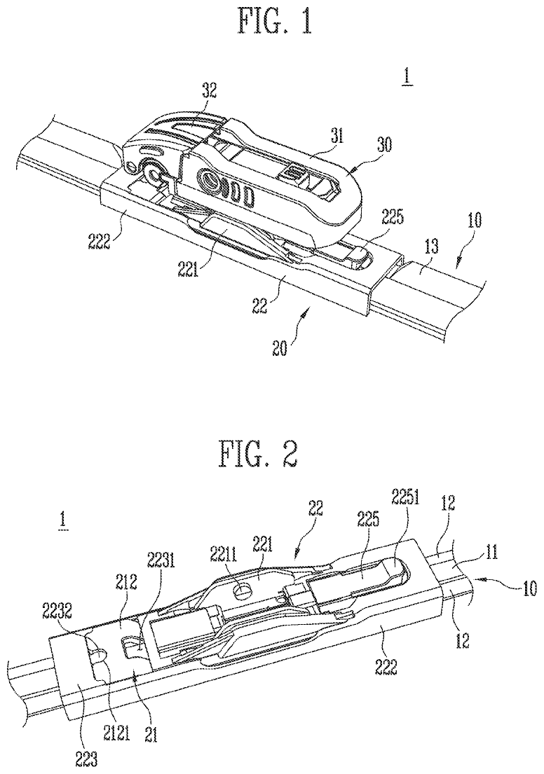

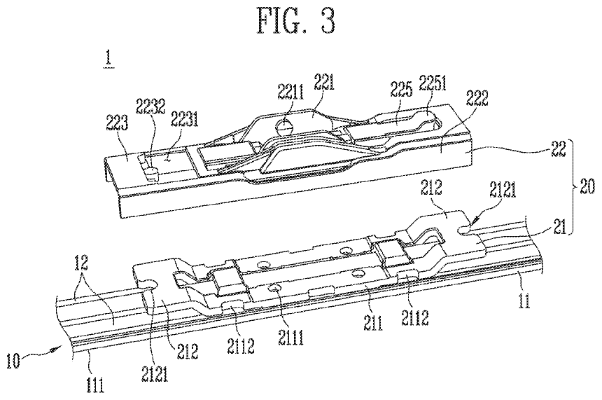

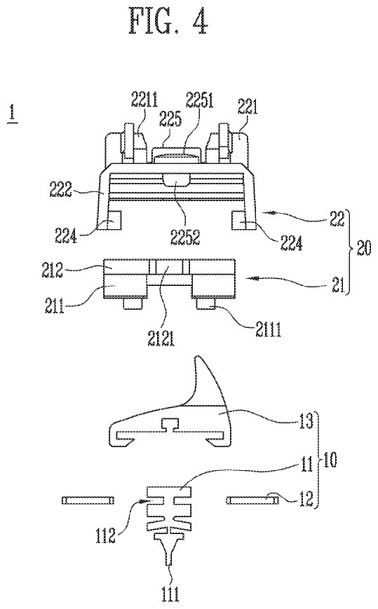

FIG. 1 is a perspective view of a wiper device according to a first embodiment of the present invention, FIG. 2 is a perspective view of a wiper blade assembly according to the first embodiment of the present invention, and FIGS. 3 and 4 are exploded-perspective views of the wiper blade assembly according to the first embodiment of the present invention.

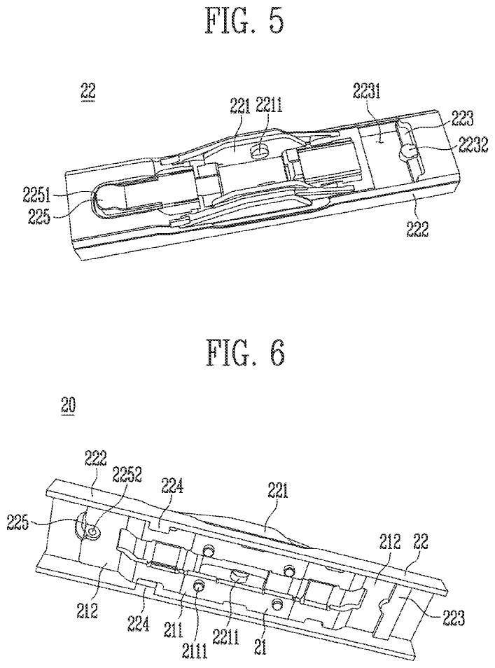

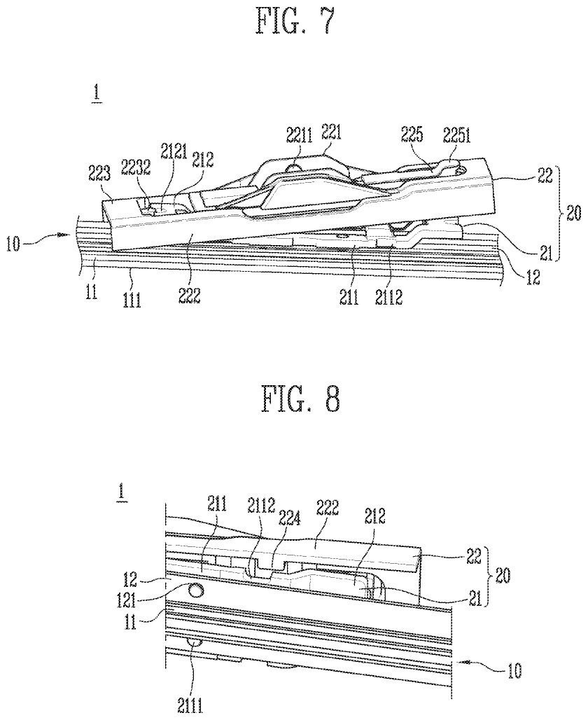

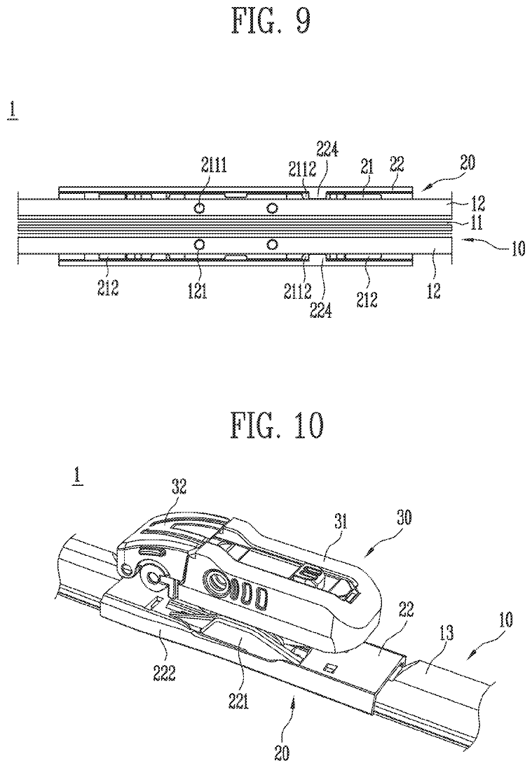

Also, FIGS. 5 and 6 are perspective views of a wiper-fastening apparatus according to the first embodiment of the present invention, and FIGS. 7 to 9 are views illustrating a method of using the wiper-fastening apparatus according to the first embodiment of the present invention.

Referring to FIGS. 1 to 9, a wiper device 1 according to the first embodiment of the present invention may include a wiper blade 10, an adaptor 30, and a wiper arm attached to or detached from the adaptor 30. Here, a wiper-fastening apparatus 20, which will be described below, may be used for connecting the wiper blade 10 to the adaptor 30.

Also, in the present invention, excluding the wiper arm, a combination of the wiper blade 10, the wiper-fastening apparatus 20, and the adaptor 30 may be referred to a wiper blade assembly.

The wiper-fastening apparatus 20 may not mean a component completely separate from the wiper blade 10 or the adaptor 30. The wiper-fastening apparatus 20 may form a part of the wiper blade 10. A part of the wiper-fastening apparatus 20 may be included in the wiper blade 10, and another part thereof may be included in the adaptor 30. However, throughout the specification, for convenience, it will be described below that the wiper-fastening apparatus 20 is an independent component which connects the wiper blade 10 and the adaptor 30 to each other.

For reference, hereafter, a longitudinal direction means a direction in which the wiper blade 10 extends lengthwise and a lateral direction means a direction perpendicular to the longitudinal direction. A vertical direction means a direction farther away from a target to be pressed against. It should be noted that the above directivities are not intended to limit the scope of the present invention but are merely for convenience in description of the present invention.

Also, movement described in the specification is relative and a component other than a moving target should not be construed as being limited to sticking to a fixed position.

Also, throughout the specification, the terms such as connection, fastening, engagement, fixing, and the like include indirect operating of two components with another component interposed therebetween other than direct operating thereof.

The wiper arm (not shown) rotates about a base end, has an end to which the wiper blade 10 is connected, and transmits a rotational force to the wiper blade 10 so as to implement cleaning of the target to be pressed against using the wiper blade 10.

Here, the target to be pressed against may be a windshield of a vehicle but is not limited thereto, and all objects to be cleanable by sliding may become targets to be pressed against.

The wiper arm is connected, directly or indirectly, to a driving source (motor or the like) provided in the vehicle or the like so that an end of the wiper arm draws an arc due to a rotational force of the driving source. Here, since the wiper blade 10 is connected to the end of the wiper arm, the wiper blade 10 may move in a certain route to implement cleaning while being pressed against the target.

The wiper arm may have a variety of unlimited shapes, and a shape of the adaptor 30 may vary freely corresponding to a shape of the wiper arm. However, the adaptor 30 may be provided as a multi-fastening type to which a plurality of wiper arms having different shapes are selectively couplable.

The adaptor 30 included in the present invention may be an intermediate connector configured to connect the wiper arm to the wiper blade 10 and include a body 31 and a cap 32.

The wiper arm may be basically connected to the body 31, and the cap 32 may be configured to impart a locking function to suppress separation of the wiper arm fastened to the body 31.

A structure or the like of the adaptor 30 may vary freely according to the shape of the wiper arm as described above, and the present invention may employ a plurality of well-known conventional adaptors 30.

The adaptor 30 may be hinge-connected to the wiper-fastening apparatus 20, which will be described below. Accordingly, the adaptor 30 may be provided to be hinge-rotatable on the basis of a hinge shaft 2211 provided in the middle of the wiper blade 10.

Here, the hinge shafts 2211 are provided to be parallel laterally. Accordingly, the wiper blade 10 may hinge-rotate on the basis of the adaptor 30 so as to maintain a state of being completely pressed against the target.

The wiper blade 10 cleans a surface of the target by moving while being pressed against the surface of the target. Here, as described above, the target may be one of all objects such as a windshield or the like of a vehicle which are cleanable by sliding.

The wiper blade 10 may include a contact member 11, an elastic member 12, and a cover member 13. The contact member 11 is pressed against the surface of the target directly and slides along the surface. The contact member 11 has a sectional structure configured to smoothly slide for cleaning by suitably rubbing with the surface while being pressed against the surface. As an example, the contact member 11 may have a shape in which a V-shaped cross section extends along a longitudinal direction as shown in FIG. 4 or the like.

That is, the contact member 11 may be provided in a shape with a reduced contact area with the target. Also, the contact member 11 may include a material having a buffering force such as rubber and the like to be pressed against the surface.

A contact side 111 of the contact member 11 may have a shape different from that of the surface of the target when an external force is not applied. However, when an elastic force is received from the elastic member 12 and the wiper blade 10 is coupled to the wiper arm through the adaptor 30, the contact member 11 is pressed against the target and the contact side 111 may be naturally modified into a shape which coincides with the surface of the target.

The contact member 11 may be engaged with the elastic member 12. The contact member 11 and the elastic member 12 may be connected to each other using a method in which the elastic member 12 is inserted laterally into a furrow 112 provided in the contact member 11.

However, the contact member 11 and the elastic member 12 may not be fastened firmly only through coupling therebetween. An inner side of the elastic member 12 may be mounted on the contact member 11 and an outer side thereof may be surrounded by the cover member 13, which will be described below, so as to be fixed between the contact member 11 and the cover member 13.

The elastic member 12 applies an elastic force to the contact member 11. The elastic member 12 may include a material (metal or the like) having rigidity in comparison to the contact member 11 or the cover member 13 which will be described below and may be a component for maintaining a long shape of the wiper blade 10.

As an example, the elastic member 12 may be provided in a shape of a leaf spring or the like. However, a structure or material thereof may vary as long as the contact member 11 is able to be completely pressed against the target.

A pair of such elastic members 12 may be provided on both sides of the contact member 11 laterally. To this end, in the contact member 11, the furrows 112 for inserting the elastic members 12 may be provided on both sides as shown in FIG. 4.

The elastic member 12 applies an elastic force to the contact member 11 to return to a curve shape benter than the surface of the target. Accordingly, when the contact member 1 is pressurized toward the target by the wiper arm, the contact side 111 of the contact member 11 may be deformed and apply a force of pushing the target but may be firmly pressed against the target while remaining in a state of being pushed by the wiper arm.

The cover member 13 is provided on the contact member 11 to be on the opposite side to the target. The cover member 13 may finish a connection part of the contact member 11 and the elastic member 12 so as to secure aesthetics and to prevent the elastic member 12 from being separated.

In detail, the cover member 13 may have a structure having a staple-shaped cross section in which both sides surround the elastic member 12 inserted into the furrow 112 of the contact member 11 laterally so that an inside of the elastic member 12 may be laterally covered by the contact member 11 and an outside thereof may be laterally covered by the cover member 13.

That is, the cover member 13 and the contact member 11 may be coupled to each other with the elastic member 12 therebetween. However, a variety of fixing structures may be applied in addition to the above-described method.

A bottom of the cover member 13 may be configured to surround the elastic member 12 connected to the contact member 11 as described above. On the other hand, a top of the cover member 13 may be a part placed on the target and exposed outward.

Here, the top of the cover member 13 may be provided to have a structure which disperses wind so as not to receive windage resistance to prevent the wiper blade 10 from being moved or damaged by wind while a vehicle is traveling.

As an example, the top of the cover member 13 may have a shape in which an A or mountain-shaped cross section extends along a longitudinal direction or may have a shape in which a wave-like crease-shaped cross section extends along a longitudinal direction. Here, a shape or a position of the crease may be asymmetrical. Accordingly, even when the vehicle travels at a high speed, the cover member 13 may disperse wind over the surface of the target so that the contact member 11 may not slide from the target.

Since the contact member 11 may be fixed to the target at a certain position due to the wiper arm or the like, the top of the cover member 13 may be provided to have a variety of structures in addition to the above-described shapes in consideration of windage resistance, aesthetics, and the like.

Since the cover member 13 may be provided to include a high-rigid material or structure in comparison to the contact member 11 and the elastic member 12 is accommodated between the cover member 13 and the contact member 11, the elastic member 12 including a metal or the like may be surrounded by the cover member 13 and the contact member 11 so as to prevent contact with water to suppress rusting.

A pair of such cover members 13 may be provided to be separated along a longitudinal direction. This is to fasten the wiper-fastening apparatus 20 to a central part of the wiper blade 10 in a longitudinal direction.

That is, the pair of cover members 13 may be provided on one side and the other side of the wiper-fastening apparatus 20 on the basis of the longitudinal direction. However, the wiper-fastening apparatus 20 may be at least partially overlapped with the pair of cover members 13 so as to reduce a gap between the cover member 13 and the wiper-fastening apparatus 20.

The wiper blade 10 may further include a finishing cover on both ends in the longitudinal direction. The finishing cover may be a component which is coupled to cover both ends of the cover member 13 and the contact member 11 to finish both ends of the cover member 13 and the contact member 11 and to prevent water from flowing thereinto. According to a shape of the cover member 13 or the contact member 11, the finishing cover may be modified or omitted.

The wiper-fastening apparatus 20 is an apparatus configured to fasten the adaptor 30 to the wiper blade 10 to be coupled with the wiper arm and includes a clamp 21 and a base 22.

The clamp 21 is fixed to the wiper blade 10. In detail, the clamp 21 may be fixed to the elastic member 12 of the wiper blade 10. To this end, one or more holes 121 are formed in the elastic member 12 and the clamp 21 may include protrusion portions 2111 inserted into and fastened to the holes 121 of the elastic member 12. That is, the clamp 21 may be fixed to the wiper blade 10 through a process of inserting and compressing the protrusion portion 2111 into the hole 121 of the elastic member 12 in the wiper blade 10.

To prevent the clamp 21 and the wiper blade 10 from being separated, the protrusion portion 2111 may be fastened to the hole 121 using a rivet structure. In this case, a bottom surface of the protrusion portion 2111 has a rivet-type structure and has a cross section smaller than that of the hole 121. As the bottom surface of the protrusion portion 2111 passes through the hole 121 and then a cross section of the bottom surface is expanded and modified through a riveting process, the bottom surface of the protrusion portion 2111 may be held by the hole 121 and the protrusion portion 2111 may be fastened to the hole 121 so as not to be separated therefrom.

The clamp 21 includes a fixing portion 211 fixed to the elastic member 12 and a holding portion 212 extending from the fixing portion 211. The fixing portion 211 may be provided such that the above-stated protrusion portion 2111 protrudes downward.

Also, the fixing portion 211 may have an H shape, a ladder shape, a square shape, or the like, which have an open middle part, so as to have adequate rigidity with a reduced weight. That is, the fixing portion 211 may have a shape including a pair of sides spaced apart laterally and a leg configured to connect the sides.

A groove 2112 may be provided on the side of the fixing portion 211. The groove 2112 is a component provided to pass through or hold a hook portion 224 of the base 22, which will be described below, and may have a size corresponding to the hook portion 224.

Here, as an example, the grooves 2112 may be provided on the sides at positions parallel to the leg in a lateral direction. This is to prevent rigidity of the clamp 21 from being degraded due to the grooves 2112.

However, when the sides are not perpendicular and have an uneven structure so that passing-through or holding of the hook portion 224 is implemented by a shape of the sides, the grooves 2112 may be omitted.

The holding portion 212 may extend from at least one side of the fixing portion 211 and may form a gap with the wiper blade 10. As an example, the holding portion 212 may extend from one side or the other side of the fixing portion 211 in the longitudinal direction while being biased upward in a vertical direction so as to form a vertical gap with the elastic member 12 of wiper blade 10.

The gap formed by the holding portion 212 may be used for fastening the base 22, and the clamp 21, which are going to be described below in detail.

A groove 2121 may be provided in an end of the holding portion 212 in a longitudinal direction. Here, a cross section of the groove 2121 may have a shape between a semicircle and a circle. That is, a width of an inlet of the groove 2121 is formed to be smaller than a maximum width of the groove 2121. This is a part of the uneven portion configured to couple a mounting portion 223, which will be described below, to the holding portion using a forcibly fitting method.

The holding portions 212 may be provided to extend from both sides of the fixing portion 211. In this case, the holding portion 212 on one side is engaged with the mounting portion 223 of the base 22, and the holding portion 212 on the other side is engaged with a locking portion 225 of the base 22.

However, since a pair of such holding portions 212 on both sides of the fixing portion 211 may be symmetrical, a direction of coupling the base 22 and the clamp 21 is not limited to any one direction and may be provided to be couplable in at least two directions.

The base 22 is attached to or detached from the clamp 21 and is mounted so as to allow the adaptor 30 to hinge-rotate. The base 22 may be coupled to a top of the clamp 21, and both ends of the base 22 may be provided to partially cover the cover member 13 of the wiper blade 10 as described above. The holding portion 212 of the clamp 21 may also be disposed to be overlapped with the cover member 13.

The base 22 includes a hinge portion 221, a side surface portion 222, the mounting portion 223, the hook portion 224, and the locking portion 225.

The hinge portion 221 is hinge-coupled to the adaptor 30. To this end, the hinge shaft 2211 may be provided on the hinge portion 221. A pair of such hinge shafts 2211 having an incised shape are provided to be spaced apart laterally so that the adaptor 30 may be mounted while being engaged with the pair of hinge shafts 2211.

Alternatively, the hinge shaft 2211 may be a bar shape extending laterally without being sectioned. Here, the adaptor 30 may have a structure into which the hinge shaft 2211 is inserted and may be mounted on the hinge portion 221 while being engaged with the hinge shaft 2211.

The side surface portions 222 are formed to extend downward from both sides of the hinge portion 221 in a lateral direction. The base 22 may have an upside-down U-shaped cross section due to the side surfaces portion 222 and the hinge portion 221.

A middle part of the elastic member 12 of the wiper blade 10 may be mounted on insides of the pair of side surface portions 222. Here, a bottom end of the side surface portion 222 may be provided to extend below at least the elastic member 12.

The hook portion 224 may be provided on the side surface portion 222, and the hook portion 224 may be provided to protrude inward from a bottom end of the side surface portion 222.

The mounting portion 223 is provided on one side of the hinge portion 221 in a longitudinal direction and is inserted into the gap. The mounting portion 223 may form a through hole 2231, into which the holding portion 212 is inserted, between the mounting portion 223 and the hinge portion 221. When the holding portion 212 passes through the through hole 2231 and is held by the mounting portion 223, the mounting portion 223 may be partially introduced into the gap between the holding portion 212 and the elastic member 12 naturally.

However, in the embodiment, to allow the holding portion 212 to pass through a through portion, the base 22 may be tilted in a vertical direction as shown in FIG. 7. This will be described below in a description of coupling the base 22 to the clamp 21.

Uneven portions may be provided on the mounting portion 223 and the holding portion 212. The uneven portions may each include the groove 2121 described above with respect to the holding portion 212 and a protrusion 2232 provided on the mounting portion 223. Since the protrusion 2232 may have a shape between a semicircle and a circle to correspond to a shape of the groove 2121, when the protrusion 2232 is press-fitted into the groove 2121 provided in the holding portion 212 at a position corresponding to the protrusion 2232, the protrusion 2232 and the groove 2121 may be fastened to each other so as not to be easily separated from each other.

However, the groove 2121 and the protrusion 2232 may be disposed differently from the above description. As an example, it is possible to implement a modified embodiment in which the groove 2121 is provided in the mounting portion 223 and the protrusion 2232 is provided on the holding portion 212.

The hook portion 224 is provided on the other side of the hinge portion 221 in a longitudinal direction to be biased from the clamp 21 or be held by the clamp 21 in a vertical direction according to a degree at which the mounting portion 223 is inserted into the gap.

The hook portion 224 may be provided on a side opposite the mounting portion 223 on the basis of the hinge shaft 2211 and is provided on the side surface portion 222 to protrude inward. The hook portion 224 may be a component in relation to the groove 2112 provided on the fixing portion 211 of the clamp 21.

When a user is intended to fasten the base 22 to the clamp 21, the user may mount the base 22 on the clamp 21 so as to allow a position of the hook portion 224 provided on the base 22 to correspond to a position of the groove 2112. Here, as the base 22 is mounted on the clamp 21, the hook portion 224 may pass the groove 2112 and be disposed below the fixing portion 211.

Subsequently, when the base 22 is moved in a longitudinal direction in comparison to the clamp 21, when viewed from a vertical direction, the hook portion 224 is disposed to be biased from the groove 2112. Accordingly, since upward movement of the hook portion 224 is restricted by the fixing portion 211, upward separation of the base 22 may be restricted.

In detail, the base 22 is in a first state (a fastening-preparation state) in which the holding portion 212 passes through the through hole 2231 and is held by the mounting portion 223 while the hook portion 224 is tilted in a vertical direction to be placed above the fixing portion 211.

Subsequently, when the hook portion 224 moves downward in comparison to the first state so that the base 22 is parallel to the clamp 21 in a vertical direction, the first state changes to a second state (intermediate-fastening state) in which the hook portion 224 passes through the groove 2112 and is disposed below the fixing portion 211.

Subsequently, when the base 22 moves along a longitudinal direction relative to the clamp 21, the second state changes to a third state (complete fastening state) in which the holding portion 212 is mounted on the mounting portion 223 so that the hook portion 224 is placed to be biased from the groove 2112.

Accordingly, since a state sequentially switches between the first state to the third state as described above, the base 22 may be fastened to the clamp 21 or released from the clamp 21.

However, to maintain the third state, the above-described fastening force caused by forcible insertion of the uneven portions may be utilized, and additionally, the locking portion 225 provided on the base 22 may be used.

The locking portion 225 interferes with one end of the clamp 21 fixed to the wiper blade 10 and blocks longitudinal movement of the clamp 21 in the third state. The locking portion 225 may be provided on the other side of the hinge portion 221 in a longitudinal direction and be provided opposite the mounting portion 223 on the basis of the hinge shaft 2211.

When the base 22 is moved rightward on the basis of FIG. 8 so that the hook portion 224 is disposed to be biased from the groove 2112 in a vertical direction to maintain a state in which the base 22 is fastened to the clamp 21, the uneven portions provided on the mounting portion 223 and the holding portion 212 are engaged with each other. Here, when an external force beyond a coupling force of the uneven portions is applied and the base 22 moves leftward, the hook portion 224 may be placed at a position corresponding to the groove 2112 so as to separate the base 22.

However, although there is no problem when an external force intended to separate the base 22 is applied, it is necessary to restrict unexpectedly generated leftward movement of the base 22 when separation of the base 22 is unnecessary.

Accordingly, the locking portion 225 may be configured to restrict leftward movement of the base 22 when the base 22 is in the third state of being completely fastened to the clamp 21. As an example, the locking portion 225 may be provided to protrude to come into contact with one end of the holding portion 212 provided on the other side of the mounting portion 223 on the fixing portion 211 so as to suppress movement of the base 22 through contact between the locking portion 225 and the holding portion 212 unless the locking portion 225 is biased from one end of the holding portion 212.

The locking portion 225 may be provided in a cantilever provided to be movable in a vertical direction due to an elastic force and configured to switch between a locked state of facing one end of the clamp 21 to block longitudinal movement of the clamp 21 and an unlocked state of elastically deforming in a vertical direction to be biased from the one end of the clamp 21 and allow the longitudinal movement of the clamp 21.

That is, when the hook portion 224 passes through the groove 2112 and the base 22 is mounted on the clamp 21 and then the base 22 moves longitudinally in comparison to the clamp 21 and is completely fastened, since the locking portion 225 protrudes from the clamp 21 to face one end of the holding portion 212, the longitudinal movement of the clamp 21 on the basis of the base 22 is restricted.

However, when the base 22 is mounted on the clamp 21 (in the second state), the locking portion 225 may come into contact with a top surface of the holding portion 212 and be moved upward. When the base 22 moves longitudinally (in the third state), the locking portion 225 may deviate from the top surface of the holding portion 212 and move downward due to an elastic force so as to be placed at a position facing the one end of the holding portion 212.

Basically, the locking portion 225 may have an elastic force intended to maintain the locked state. Accordingly, unless an external force is applied to the locking portion 225, the hook portion 224 does not move to a position corresponding to the groove 2112, and thus the fastening between the base 22 and the clamp 21 is maintained.

However, when the locking portion 225 is moved upward by an external force, the locking portion 225 is biased upward from the one end of the holding portion 212 and placed to be biased from the clamp 21. Here, as longitudinal movement of the clamp 21 on the basis of the base 22 is allowed, the hook portion 224 moves to a position corresponding to the groove 2112 so that the base 22 may be separated.

To unlock the locking portion 225, the locking portion 225 may include a step portion 2251 which protrudes upward, is caught on a finger, and receives an external force for changing to the unlocked state. That is, the step portion 2251 is a component provided for user convenience and may be a part configured to be easily held by a finger of the user.

The locking portion 225 may have a shape so as not to protrude separately or a shape that does not receive an external force well. Here, the user may move the locking portion 225 upward using a tool to implement unlocking.

As described above, since the holding portions 212 provided on both sides of the fixing portion 211 may be symmetrical to each other, the groove 2121 may be provided in the holding portion 212 which comes into contact with the locking portion 225 other than the holding portion 212 engaged with the mounting portion 223. Here, the locking portion 225 includes a protrusion 2252 protruding downward corresponding to the groove 2121 so that the protrusion 2252 may be located inside the groove 2121 so as to implement a locking function.

In detail, related to the protrusion 2252 and the groove 2121 provided on the locking portion 225 and the holding portion 212, in the locked state, the protrusion 2252 is located inside the groove 2121 so that relative longitudinal movement of the clamp 21 on the basis of the base 22 is blocked to be locked. In the unlocked state, the locking portion 225 is moved upward and the protrusion 2252 deviates upward from the groove 2121 so that the relative longitudinal movement of the clamp 21 on the basis of the base 22 may be allowed and unlocked.

Hereinafter, referring back to the drawings, a method of fastening the base 22 and the clamp 21 will be described.

First, as shown in FIG. 3, the fixing portion 211 of the clamp 21 may be fastened to the elastic member 12 of the wiper blade 10 through the protrusion portion 2111.

Here, the user may hold and allow the base 22 to approach the clamp 21 while being tilted in a vertical direction so that the holding portion 212 may pass through the through hole 2231 as shown in FIG. 7. The holding portion 212 passing through the through hole 2231 may be held by the mounting portion 223. In this state, the hook portion 224 may be placed at a position corresponding to the groove 2112 in a vertical direction (in the first state) as shown in FIG. 8.

Subsequently, the user allows the base 22 to be parallel to the clamp 21 so that the hook portion 224 passes through the groove 2112. In this case, the hook portion 224 still corresponds to the groove 2112 in a vertical direction and is located below the fixing portion 211 (in the second state).

Subsequently, when the user moves the base 22 in a vertical direction, the protrusion 2232 of the mounting portion 223 is press-fitted into the groove 2121 of the holding portion 212 on one side, the locking portion 225 is placed on the holding portion 212 on the other side to face the holding portion 212, and the hook portion 224 is disposed to be biased from the groove 2112 in a vertical direction (in the third state). Accordingly, since the hook portion 224 is held so as not to be moved upward from the clamp 21, the base 22 may be stably fastened to the clamp 21.

Also, although the protrusion 2252 of the locking portion 225 comes into a surface of the holding portion 212 on the other side and the locking portion 225 is moved upward slightly in the second state, the protrusion 2252 of the locking portion 225 is introduced into and mounted on the groove 2121 of the holding portion 212 on the other side in the third state. Here, since the groove 2121 surrounds the protrusion 2252 and blocks the base 22 from moving in a direction of being unlocked from the clamp 21, the locked state may be maintained.

As described above, in the embodiment, it is possible to secure a firm fastening force of the base 22 with respect to the clamp 21 using the hook portion 224, the locking portion 225, and the like while the base 22 is tilted and placed horizontally to be fastened to the clamp 21.

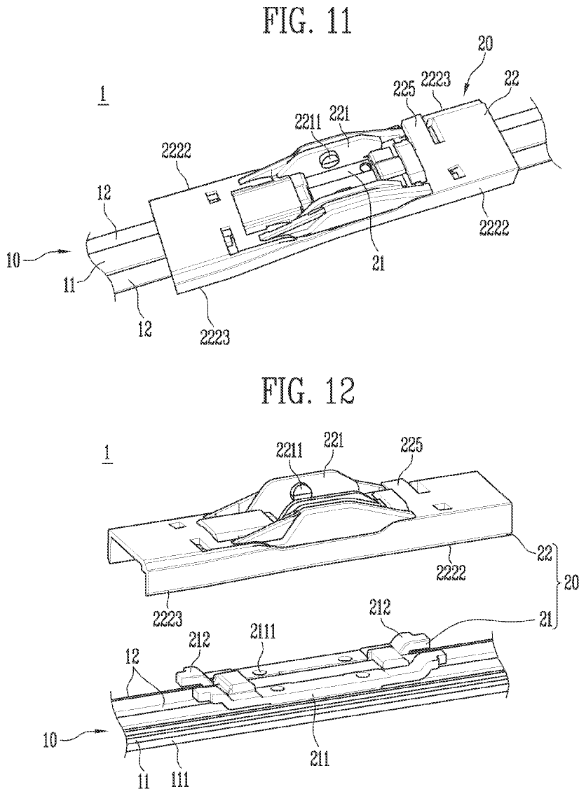

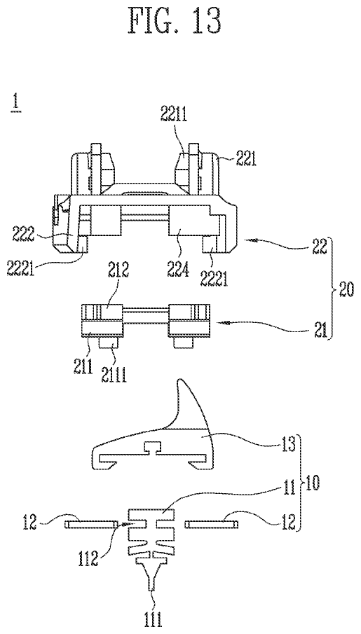

FIG. 10 is a perspective view of a wiper device according to a second embodiment of the present invention, FIG. 11 is a perspective view of a wiper blade assembly according to the second embodiment of the present invention, and FIGS. 12 and 13 are exploded-perspective views of the wiper blade assembly according to the second embodiment of the present invention.

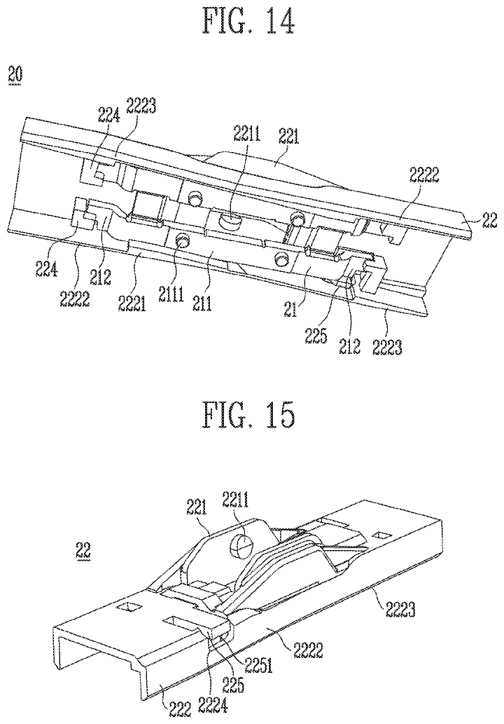

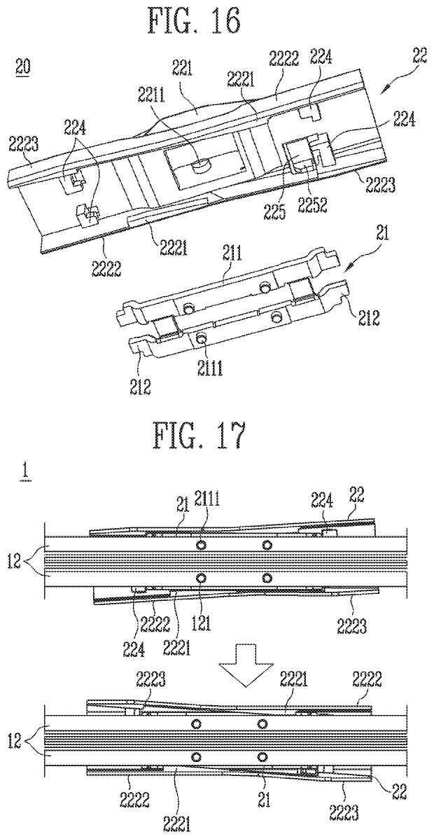

Also, FIGS. 14 and 15 are perspective views of a wiper-fastening apparatus according to the second embodiment of the present invention, FIG. 16 is an exploded perspective view of the wiper-fastening apparatus according to the second embodiment of the present invention, and FIG. 17 is a view illustrating a method of using the wiper-fastening apparatus according to the second embodiment of the present invention.

Referring to FIGS. 10 to 17, in comparison to the first embodiment, in the wiper device 1 according to the second embodiment of the present invention, a structure of the wiper-fastening apparatus 20 may differ from that of the first embodiment, and descriptions of the wiper blade 10, the adaptor 30, or the like may be equal to those of the first embodiment.

Accordingly, hereinafter, differences between the present embodiment and the previous embodiment will be mainly described, and a description of some parts will be skipped and the above description thereof will be referred to.

In the embodiment, the wiper-fastening apparatus 20 includes the clamp 21 and the base 22. Here, the clamp 21 may be fixed to the wiper and include the fixing portion 211 and the holding portion 212, and the base 22 may include the hinge portion 221, the side surface portion 222, the hook portion 224, and the locking portion 225.

The embodiment, in comparison to the previous embodiment, is similar in that the holding portion 212 is utilized for fastening the base 22 and the clamp 21. However, there is a different in that the fixing portion 211 may also be utilized for fastening the base 22 and the clamp 21.

In the base 22 of the embodiment, the side surface portions 222 provided to extend downward from both sides of the hinge portion 221 in a lateral direction each include a protruding portion 2221 provided to be held by the fixing portion 211 of the clamp 21 directly or indirectly. The protruding portion 2221 may be provided to protrude inward from the side surface portion 222 and configured to be biased from the clamp 21 in a vertical direction or to be held by the clamp 21 depending on an angle formed by a longitudinal direction of the hinge portion 221 in comparison to a longitudinal direction of the wiper blade 10.

In detail, the side surface portion 222 includes a parallel surface portion 2222 and a tilted surface portion 2223 which are continuous along a longitudinal direction. The parallel surface portion 2222 is a part provided to be parallel to a longitudinal direction of the hinge portion 221 on the basis of a completely fastened state of the base 22 and the clamp 21.

The protruding portion 2221 configured to fasten the clamp 21 may be provided to protrude inward from a bottom end of the parallel surface portion 2222. A degree of protruding of the protruding portion 2221 may be determined according to a tilt angle of the tilted surface portion 2223.

The tilted surface portion 2223 is provided to be tilted outward at a certain degree in comparison to the parallel surface portion 2222. That is, the side surface portion 222 may have a shape partially protruding outward along a lateral direction due to the tilted surface portion 2223.

In the embodiment, the clamp 21 fixed to the wiper blade 10 may rotate about a rotational center in a vertical direction so as to be fastened to or released from the base 22.

In detail, when the wiper blade 10 is placed to be parallel to the tilted surface portion 2223, the clamp 21 fixed to the wiper blade 10 to be parallel in a longitudinal direction may be tilted in a longitudinal direction with the base 22. Here, the protruding portion 2221 provided on the parallel surface portion 2222 may be provided to be biased from the fixing portion 211 of the clamp 21 in a vertical direction.

That is, when the wiper blade 10 is parallel to the tilted surface portion 2223, since the protruding portion 2221 is located deviating from the fixing portion 211, the base 22 may be mounted in a vertical direction with respect to the clamp 21. A state in which mounting is performed as described above may be referred to as the first state (fastening preparation state).

Subsequently, when the wiper blade 10 rotates on the basis of the base 22, the wiper blade 10 changes to a state of being parallel to the parallel surface portion 2222 and not the tilted surface portion 2223. Here, in the clamp 21 fixed to the wiper blade 10, the protruding portion 2221 and the fixing portion 211 may be placed to be overlapped with each other in a vertical direction. Accordingly, the protruding portion 2221 is located below the fixing portion 211 so that the base 22 is fastened so as not to be separated upward from the clamp 21. This state may be referred to as the second state (completely fastened state).

That is, the protruding portion 2221 provided on the parallel surface portion 2222 may be biased from the clamp 21 fixed to the wiper blade 10 in the first state in which the wiper blade 10 is mounted to be parallel to the tilted surface portion 2223 (tilted from the parallel surface portion 2222) and be released from the clamp 21.

On the other hand, when the wiper blade 10 rotates to be parallel to the parallel surface portion 2222 (tilted from the tilted surface portion 2223), the protruding portion 2221 is held below the clamp 21 fixed to the wiper blade 10 so that upward movement of the protruding portion 2221 may be restricted by the fixing portion 211 of the clamp 21 so as to fasten the base 22 and the clamp 21 to each other.

However, to allow the protruding portion 2221 to be engaged with a bottom side of the fixing portion 211, the fixing portion 211 of the clamp 21 may be provided to have a width greater than that of the elastic member 12 of the wiper blade 10. Accordingly, the protruding portion 2221 may be placed on and held by the bottom side of the fixing portion 211 which does not come into contact with the elastic member 12 and protrudes outward from the elastic member 12.

Alternatively, a modified example in which the fixing portion 211 includes a gap in at least a part of the elastic member 12 in a vertical direction so as to insert the protruding portion 2221 into the gap may also be possible. Also, depending on a height of the side surface portion 222, the protruding portion 2221 may be engaged with a bottom side of the elastic member 12 disposed below the fixing portion 211.

In a pair of such side surface portions 222 provided on both sides of the hinge portion 221, the parallel surface portion 2222 and the tilted surface portion 2223 may be disposed to be symmetrical to each other. As an example, to switch between the first state and the second state, point symmetry may be formed on the basis of a center about which the wiper blade 10 rotates.

That is, the parallel surface portion 2222 provided on the side surface portion 222 on one side faces the tilted surface portion 2223 provided on the side surface portion 222 on the other side in a lateral direction. Also, the tilted surface portion 2223 provided on the side surface portion 222 on the one side may face the parallel surface portion 2222 provided on the side surface portion 222 on the other side in a lateral direction.

Since the above-described protruding portion 2221 may be provided on the parallel surface portion 2222, the protruding portions 2221 provided on the respective side surface portions 222 may be disposed to be at least partially biased from each other along a lateral direction.

The base 22 may basically use the protruding portion 2221 provided on the side surface portion 222 to be fastened to the clamp 21 and may use the hook portion 224 and the locking portion 225 to secure an additional fastening force.

The hook portion 224 may be configured to be held by or released from the holding portion 212 of the clamp 21. The hook portion 224 may be configured to deviate from the gap between the holding portion 212 and the elastic member 12 in the first state and may be inserted into the gap and held by the holding portion 212 in the second state.

The hook portion 224 may be provided at a position corresponding to the 25 holding portion 212 in an internal space between the pair of side surface portions 222, and four hook portions 224, in total, may be provided to be held by corners of the holding portion 212.

However, like that shown in the drawing, the holding portion 212 may have corners partially recessed and cut so that a holding area between the hook portion 224 and the holding portion 212 is zero in the first state. Accordingly, since the hook portion 224 is not held by the holding portion 212 in the first state in which the wiper blade 10 is parallel to the tilted surface portion 2223, the base 22 may be smoothly separated from the clamp 21.

However, a shape, size, or the like of the hook portion 224 or the holding portion 212 may vary according to a tilt angle of the tilted surface portion 2223. Unlike that shown in the drawing, a chamber may be applied or only a size may be reduced while a shape is maintained unchanged.

In the second state in which the base 22 is completely fastened to the clamp 21, the locking portion 225 may interfere with a side surface of the clamp 21 fixed to the wiper blade 10 and may block rotations of the wiper blade 10 and the clamp 21.

In the embodiment, unlike the previous embodiment, since it is possible to switch between the first state prior to being fastened and the second state of being fastened completely due to horizontal rotation of the wiper blade 10 (particularly, the elastic member 12 to which the clamp 21 is fixed), when horizontal rotation of the clamp 21 in the second state is blocked, it is possible to suppress switching from the second state to the first state.

To this end, the locking portion 225 may be provided in a cantilever provided to be movable in a vertical direction due to an elastic force and configured to switch between a locked state of facing the side surface of the clamp 21 to block the rotation of the clamp 21 and an unlocked state of elastically deforming to be biased from the side surface of the clamp 21 and allow the rotation of the clamp 21.

However, when the base 22 is mounted on the clamp 21 so that the elastic member 12 of the wiper blade 10 is parallel to the tilted surface portion 2223, the locking portion 225 (in detail, the protrusion 2252 protruding downward from the locking portion 225) may come into contact with the clamp 21 and be moved upward by the clamp 21.

Subsequently, when the wiper blade 10 and the clamp 21 are rotated horizontally in one direction so that the elastic member 12 is parallel to the parallel surface portion 2222, the clamp 21 moving the protrusion 2252 upward is biased from the protrusion 2252 of the locking portion 225 and the locking portion 225 moves downward due to an elastic force so that the protrusion 2252 faces the side surface of the clamp 21 so as to block rotation of the clamp 21 in an opposite direction.

In the second state in which the locking is performed by the locking portion 225, when locking is released to separate the base 22 from the clamp 21, the user moves the locking portion 225 upward using a finger to bias the protrusion 2252 of the locking portion 225 upward from the clamp 21 so as to enable the clamp 21 and the wiper blade 10 to rotate horizontally.

Here, for user convenience, the step portion 2251 which holds a finger and receives an external force for changing to the unlocked state may be provided on the locking portion 225. However, in comparison to the previous embodiment, in the embodiment, the step portion 2251 may be provided to be adjacent to the side surface portion 222. In this case, the side surface portion 222 may include an opening portion 2224 formed near the step portion 2251 to be recessed to space the step portion 2251 apart from the side surface portion 222 so as to avoid interference with the step portion 2251.

However, when the locking portion 225 extends to protrude upward and the step portion 2251 is located at a position above the side surface portion 222, the opening portion 2224 may not be provided in the side surface portion 222.

Hereinafter, referring back to the drawings, a method of fastening the base 22 and the clamp 21 will be described.

First, as shown in FIG. 12, the fixing portion 211 of the clamp 21 may be fastened to the elastic member 12 of the wiper blade 10 through the protrusion portion 2111.

Here, the user allows the base 22 to approach from above the clamp 21 fixed to the elastic member 12. To mount the base 22 on the clamp 21, a relative angle between the base 22 and the clamp 21 is set so that a longitudinal direction of the elastic member 12 is parallel to the tilted surface portion 2223 of the base 22.

When the longitudinal direction of the elastic member 12 is parallel to the parallel surface portion 2222 of the base 22, the protruding portion 2221 and the hook portion 224 are held by the fixing portion 211 or the holding portion 212 of the clamp 21 and blocked from moving downward even when the base 22 is moved downward to be mounted on the clamp 21.

That is, it is necessary for the user to adjust the tilted surface portion 2223 of the base 22 to the longitudinal direction of the clamp 21 or the elastic member 12 so that the protruding portion 2221 is biased from the fixing portion 211 of the clamp 21 and the hook portion 224 is biased from the holding portion 212 of the clamp 21 for the base 22 to be completely mounted on the clamp 21 in a vertical direction.

When the base 22 is mounted on the clamp 21, a state changes to that shown in an upper part of FIG. 17 (the first state). In this case, the tilted surface portion 2223 is parallel to the longitudinal direction of the elastic member 12, the parallel surface portion 2222 including the protruding portion 2221 is provided to be tilted at a certain angel from the longitudinal direction of the elastic member 12, and the protruding portion 2221 is located outside the fixing portion 211 of the clamp 21 in a lateral direction and located below the fixing portion 211 in a vertical direction.

Also, in this case, the protrusion 2252 of the locking portion 225 is moved upward by the clamp 21 so that the step portion 2251 may be biased upward slightly.

Subsequently, when the base 22 is rotated horizontally on the basis of the clamp 21, the tilted surface portion 2223 is tilted from the longitudinal direction of the elastic member 12 and the parallel surface portion 2222 is placed to be parallel to the longitudinal direction of the elastic member 12. Also, the protruding portion 2221 moves toward a bottom side of the fixing portion 211 and is overlapped with the fixing portion 211 in a vertical direction so that upward movement of the protruding portion 2221 is blocked by the fixing portion 211 (the second state).

Also, as the hook portion 224 is held by the corners of the holding portion 212 and the clamp 21 is biased from the protrusion 2252 of the locking portion 225 in a vertical direction, the locking portion 225 is moved downward by an elastic force and horizontal rotation of the clamp 21 is suppressed by the protrusion 2252 facing the side surface of the clamp 21.

That is, the base 22 may be fastened not to be separated upward from the clamp 21 by the protruding portion 2221 located below the fixing portion 211 and the hook portion 224 engaged with a bottom side of the holding portion 212. Also, the horizontal rotation of the clamp 21 is restricted by the locking portion 225 facing the side surface of the clamp 21 so that the clamp 21 and the base 22 may be locked so as not to be released.

When the user intends to separate the base 22 from the clamp 21, the user moves the step portion 2251 upward using a finger so that the protrusion 2252 of the locking portion 225 is biased from the side surface of the clamp 21 in a vertical direction. Accordingly, the clamp 21 is able to rotate horizontally.

Here, when the base 22 is rotated on the basis of the clamp 21, the tilted surface portion 2223 is placed to be parallel to the longitudinal direction of the elastic member 12 and the protrusion portion 2221 deviates from the bottom side of the fixing portion 211 so that the protruding portion 2221 and the fixing portion 211 are placed to be biased in a vertical direction, and the hook portion 224 also deviates from the gap and is biased from the holding portion 212 in a vertical direction.

Accordingly, since the second state changes to the first state and the base 22 deviates upward from the clamp 21, the user may move the base 22 upward and separate the base 22 from the clamp 21 fixed to the wiper blade 10.

As described above, in the embodiment, the base 22 including the tilted surface portion 2223 and the protruding portion 2221 on the side surface portion 222 rotates horizontally from the clamp 21 so as to fasten the base 22 and the clamp 21, and a fastened state may be more stably maintained utilizing the hook portion 224 and the locking portion 225.

According to the present invention, a wiper-fastening apparatus, a wiper blade assembly, and a wiper device may efficiently improve a coupling structure between a wiper blade and an adaptor by allowing a base to be easily attached to or detached from a clamp fixed to a blade while securing a firm fastening force.

Although the exemplary embodiments of the present invention have been described above, these are merely for describing the present invention in detail and the present invention is not limited thereto. Also, it is apparent that a variety of modifications and improvements thereof may be made by one of ordinary skill in the art without departing from the technical concept of the present invention.

All simple modifications and changes of the present invention are included within the scope of the present invention, and a detailed scope of the present invention will be defined by the following claims.

What is claimed is:

1. A wiper-fastening apparatus configured to fasten a wiper arm coupling adaptor to a wiper blade, the wiper-fastening apparatus comprising a base attached to or detached from a clamp fixed to the wiper blade and on which the adaptor is mounted to be hinge-rotated,
wherein the base comprises:
a hinge portion which is hinge-coupled to the adaptor; and
a lateral portion extending downward from both sides in a width direction of the hinge portion and inside which the wiper blade is mounted, and
wherein the lateral portion comprises a protruding portion biased from the clamp or held by the clamp in a vertical direction depending on an angle formed by a longitudinal direction of the wiper blade and a longitudinal direction of the hinge portion.

2. The wiper-fastening apparatus of claim 1, wherein the lateral portion comprises:
a parallel surface portion provided to be parallel to the longitudinal direction of the hinge portion; and
a tilted surface portion provided to be tilted outward at a certain angle in comparison to the parallel surface portion so as to switch between a first state in which the wiper blade is mounted to be parallel to the tilted surface portion and a second state in which the wiper blade rotates and is mounted to be parallel to the parallel surface portion in comparison to the first state, and
wherein the parallel surface portion comprises the protruding portion held by the clamp fixed to the wiper blade in the second state.

3. The wiper-fastening apparatus of claim 2, wherein in the first state, the protruding portion is biased and released from the clamp fixed to the wiper blade.
